(19) United States
(12) Patent Application Publication
(10) Pub. No.: US 2024/0054501 A1
(43) Pub. Date: Feb. 15, 2024

(54) Systems and Methods for Improving Customer Satisfaction Post-Sale

(71) Applicant: Magnify Technologies Inc., Seattle, WA (US)

(72) Inventors: Joshua Crossman, Bend, OR (US); Sajo Poovathukunnel Jacob, Issaquah, WA (US); Wenduo Wang, Redmond, WA (US); Shayan Nathan, Kirkland, WA (US)

(21) Appl. No.: 18/232,505

(22) Filed: Aug. 10, 2023

Related U.S. Application Data
(60) Provisional application No. 63/397,708, filed on Aug. 12, 2022.

(51) Int. Cl. G06Q 30/016; G06Q 30/0202

(52) U.S. Cl. CPC G06Q 30/016; G06Q 30/0202

(57) ABSTRACT

Systems and methods for improving the post-sale satisfaction of customer accounts (and the associated users) with software applications, products, and services. This may include the creation of a more personalized form of user assistance in one or more of on-boarding, training, using, or resolving problems encountered when using a software application, product, or service. The disclosed methods and approaches support customized, personalized, and automatically generated interactions with end users and may provide one or more of benefits, such as reducing churn, retaining company accounts, and/or upselling other products and services using an appropriate and account (or user)-specific form of incentive.

### CROSS REFERENCE TO RELATED APPLICATION

This application claims the benefit of U.S. Provisional Application No. 63/397,708, filed Aug. 12, 2022, entitled “Systems and Methods for Improving Customer Satisfaction Post-Sale”, the disclosure of which is incorporated, in its entirety (including the Appendix) by this reference.

### BACKGROUND

Although much effort is put into the sale of software and software-based services, relatively little is directed towards assisting users to use the software more effectively. Even if such efforts are made, they are typically of a generic nature and often provided only in response to a company account or user requesting assistance. For example, training in the use of software applications is often provided at a high-level for broad feature sets for groups of users and is rarely made specific to a user or an unusual task. Further, even if this type of training is provided, it is often not recalled by a user when they encounter a problem.

At present, there is a lack of conventional products that connect disparate sources of data stores, signals or events generated by customer account or user actions and operate to predict churn or expansion opportunities (for example, to suggest an upsell of products or services) based on account or user behavior. Further, there is a lack of conventional products that use this information and data to automatically generate and present actions, training opportunities, or communications to accounts or users based on customer goals, or to customize the actions or suggestions at the account or user level.

Instead, conventional approaches may attempt to connect a few systems or functions but rely on the customer to manually identify or generate a churn risk or product or service expansion opportunity. There are systems that attempt to generate a churn risk prediction or expansion opportunity using machine learning (ML), but they are not connected to the presentation of suggested activities or information intended to cause specific actions to achieve a desired goal.

As result, the conventional approaches and solutions result in customer accounts or users being confronted with multiple touch points, often conflicting messages, and uncoordinated suggestions of information or possible actions. For example, a user might receive an email one week highlighting a different feature than promoted in a webinar the previous week, and a still different feature than promoted by the product when they log in the next day. The result is a confusing accumulation of messages and suggestions that are difficult for a user to absorb and effectively use to improve their experience with a product or service.

Further, and importantly, these typical communications are not generated or targeted in a way to assist in achieving desired outcomes for the business that provided the software product or service to the user. This problem is increasing as new tools and platforms are created to connect with customer accounts or users and to attempt to improve the customer experience. At the same time, more and more manual work is being required by post-sales staff to produce successful outcomes for the customers and for the business that provided a product or service.

In addition, conventional approaches to customer on-boarding and training in the use of a software application typically require the user to identify and request assistance with a specific problem, rather than proactively suggesting information or an approach that might be helpful before a problem is encountered. Thus, conventional approaches can result in a reduced degree of customer satisfaction with the software or support services provided by the software provider. In a general sense, conventional approaches fail to provide sufficient user assistance in the training and use of software products and services during the entire lifecycle of customer use of the software.

Embodiments of the disclosure overcome these and other disadvantages of conventional approaches, both collectively and individually.

### SUMMARY

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

Embodiments of the disclosure are directed to systems, devices, and methods for improving the post-sale customer satisfaction with software applications and services. In some embodiments, this includes the creation of a more personalized form of user assistance in one or more of on-boarding, training, using, and resolving problems encountered when using the software applications and services. It is believed that this form of pro-active and personalized assistance is more effective at driving adoption of a product, the effective and optimal use of a product, and generating a better prediction of account or user behavior with regards to usage and satisfaction with a software product or service. The disclosed methods and approaches support customized, personalized, and automatically generated interactions with users and may provide one or more of the benefits of reducing churn, retaining company accounts, and/or upselling other products and services using an appropriate and account (or user)-specific form of incentive.

In one embodiment, the disclosure is directed to a method for improving the post-sale satisfaction of customer accounts (and the associated users) with software applications and services. An embodiment of the disclosed method may comprise one or more of the following steps, stages, processes, elements, components, operations, or functions:
Elements, components, and processes for connecting fragmented datastores, standardizing datasets, and collecting account or user behavior signals (such as, but not limited to user selections, inputs, or results of other user activities or interactions with a software application or service);
   extracting customer-account-user relationship data from one or more CRM platforms through appropriate data connectors, combining the structured CRM platform data with unstructured customer product and service usage history data, and storing it in the disclosed system's data warehouse;
Generating a Unified Feature Representation (UFR) integrating and representing customer data across the multiple platforms;
   optionally, derive new attributes (and if needed, transform the derived attributes into the UFR) from unstructured platform data and unstructured customer product and service usage history data;
      as a non-limiting example, customers of a subscription business or a consumption business may calculate revenues in different formats. For example, a subscription business customer may calculate account revenues by their contract values, while a consumption business customer may compute revenues based on service product usages. In this example, the UFR amortizes account revenues into daily, monthly or annual recurring revenues so that expansion or churn events can be defined through the increase or decrease of amortized revenue;
Elements, components, and processes responsible for orchestrating (e.g., delivering or integrating) actions into customers' core platforms and (where applicable) SaaS platforms instances used by the customer—in one embodiment, this may be accomplished by communicating with existing public and/or private “hooks” into SaaS applications (APIs or datastores, as examples) that interact with the customer account or user experience;
Elements, components, and processes responsible for “predicting” account or user behavior, forecasting revenues and product usages, personalizing actions, and initiating actions—in some embodiments, these processes may use statistical and/or machine learning (ML) techniques to perform tasks related to generating inferences, predictions, and/or recommendations. In some embodiments, the outputs of those statistical and/or ML tasks generate actions that are applied to a segment of accounts or users to achieve a desired business goal. In some embodiments, this system or set of processes may comprise one or more of:
   Feature Engineering Service—operates or functions to derive “richer” signals to enhance the representation of account and user data and characteristics;
   Predictive Modeling Service—operates or functions to “predict” the likelihood of achieving a customer-specific business objective;
   Insights Mining Service—operates or functions to measure and demonstrate the factors that impact account or user characteristics and/or recommend actions customers can take with regards to accounts or users;
   Segment Builder Service—operates or functions to identify (or help customers to identify) segments of accounts or users to apply actions to;
   Journey Builder—operates or functions to organize and compile actions and apply these actions to a selection of accounts or users;
   Experimentation Service—operates or functions to measure the effectiveness of a journey and/or its actions; and
   Journey Automation Service—operates or functions to execute journey actions to achieve a customer-specific business objective automatically (i.e., without human interaction); and
Elements, components, and processes to generate a frontend for customers of the disclosed system and platform operated by the assignee (Magnify) to interact with and operate/execute the provided functionality and services—among other functions, supports an ability to orchestrate actions via a “journey”, gathers insights and actions taken on predictions, and adds/removes data stores (sources) and manages platform integrations.

In one embodiment, the disclosure is directed to systems, devices, and methods for improving the post-sale satisfaction of customer accounts or users with software applications and services. The system may include a set of computer-executable instructions, a memory or data storage element containing the set of instructions (such as a non-transitory computer-readable medium), and an electronic processor or co-processors. When executed by the processor or co-processors, the instructions cause the processor or co-processors (or a device of which they are part) to perform a set of operations that implement an embodiment of the disclosed method or methods.

In one embodiment, the disclosure is directed to one or more non-transitory computer-readable media including a set of computer-executable instructions, wherein when the set of instructions are executed by an electronic processor or co-processors, the processor or co-processors (or a device of which they are part) perform a set of operations that implement an embodiment of the disclosed method or methods.

In some embodiments, the systems and methods disclosed herein may provide services through a SaaS or multi-tenant platform. The platform provides access to multiple entities, each with a separate presence and associated data storage on the platform. Each such presence may correspond to a user, a set of users, an entity, a set or category of entities, a set or category of users, a set or category of data, an industry, or an organization, for example. Each may access one or more services (such as applications or functionality), a set of which are instantiated in their respective presence on the platform, and which implement one or more of the methods or functions disclosed herein.

Other objects and advantages of the systems, apparatuses, and methods disclosed will be apparent to one of ordinary skill in the art upon review of the detailed description and the included figures. Throughout the drawings, identical reference characters and descriptions indicate similar, but not necessarily identical, elements. While the embodiments disclosed and/or described herein are susceptible to various modifications and alternative forms, specific embodiments are shown by way of example in the drawings and are described in detail herein. However, the embodiments are not limited to the exemplary or specific forms described. Rather, the disclosure covers all modifications, equivalents, and alternatives falling within the scope of the appended claims.

### BRIEF DESCRIPTION OF THE DRAWINGS

Embodiments of the disclosure are described with reference to the drawings, in which:

FIG. 1(a) is a diagram illustrating one or more non-limiting examples of an entity or person associated with the terms “customer”, “account”, and “user” as those terms are used herein with reference to an embodiment of the disclosure;

FIG. 1(b) is a flowchart or flow diagram illustrating a method, process, operation, or set of functions that may be used in implementing an embodiment of the disclosure;

FIG. 1(c) is a flowchart or flow diagram illustrating a method, process, operation, or set of functions that may be used in implementing an embodiment of the disclosure;

FIG. 2(a) is a diagram illustrating the primary subsystems of an embodiment of the discourse that cooperate to produce the described benefits;

FIG. 2(b) is a diagram illustrating an example embodiment of the disclosed machine Learning Engine and its associated data processing flow;

FIG. 2(c) is a diagram illustrating an embodiment of the adaptive experimentation capability that may be implemented as part of an embodiment of the disclosure;

FIG. 2(d) is a diagram illustrating an example of the customer experience when an authorized individual interacts with an embodiment of the disclosed system or platform, and the associated functions and capabilities;

FIG. 2(e) is a diagram illustrating elements, components, or processes that may be present in a computing device or system configured to implement a method, process, function, or operation in accordance with an embodiment of the system and methods disclosed herein; and

FIGS. 3-5 are diagrams illustrating a deployment of the system and methods disclosed herein as a service or application provided through a Software-as-a-Service platform, in accordance with some embodiments.

Note that the same numbers are used throughout the disclosure and figures to reference like components and features.

### DETAILED DESCRIPTION

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. The description should not be interpreted as implying any required order or arrangement among or between various steps or elements except when the order of individual steps or arrangement of elements is explicitly noted as being required.

Embodiments of the disclosed subject matter are described more fully herein with reference to the accompanying drawings, which show by way of illustration, example embodiments by which the disclosed systems, apparatuses, and methods may be practiced. However, the disclosure may be embodied in different forms and should not be construed as limited to the embodiments set forth herein; rather, these embodiments are provided so that this disclosure will satisfy the statutory requirements and convey the scope of the disclosure to those skilled in the art.

Among other forms, the subject matter of the disclosure may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods described herein may be implemented by a suitable processing element or elements (such as a processor, microprocessor, CPU, GPU, TPU, QPU, state machine, or controller, as non-limiting examples) that are part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory computer-readable data storage elements. In some embodiments, the set of instructions may be conveyed to a user over a network (e.g., the Internet) through a transfer of instructions or an application that executes a set of instructions.

In some embodiments, the systems and methods disclosed herein may provide services through a SaaS or multi-tenant platform. The platform provides access to multiple entities, each with a separate presence and associated data storage on the platform. Each such presence may correspond to a user, a set of users, an entity, a set or category of entities, a set or category of users, a set or category of data, an industry, or an organization, for example. Each may access one or more services (such as applications or functionality), a set of which are instantiated in their respective presence on the platform, and which implement one or more of the methods or functions disclosed herein.

In some embodiments, one or more of the operations, functions, processes, or methods disclosed herein may be implemented by a specialized form of hardware, such as a programmable gate array, application specific integrated circuit (ASIC), or the like. Note that an embodiment of the disclosed methods may be implemented in the form of an application, a sub-routine that is part of a larger application, a “plug-in”, an extension to the functionality of a data processing system or platform, or other suitable form. The following detailed description is, therefore, not to be taken in a limiting sense.

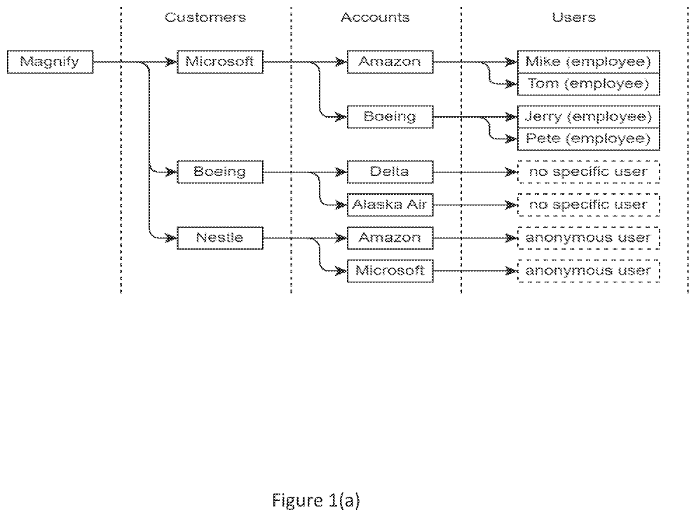

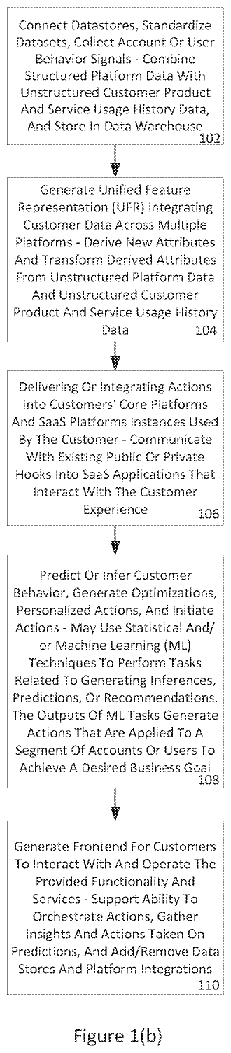

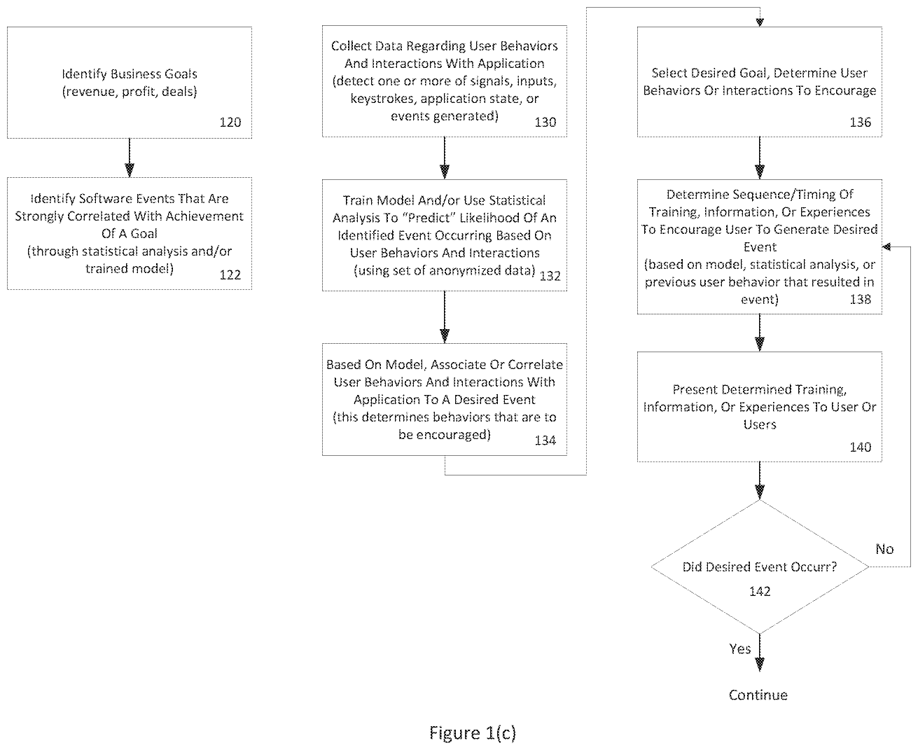

In the context of this disclosure, the following terms have at least the indicated meaning (as an example, FIG. 1(a) is a diagram illustrating one or more non-limiting examples of an entity or person associated with the terms “customer”, “account”, and “user” as those terms are used herein with reference to an embodiment of the disclosure):
Customer or tenant—refers to a company or organization which uses the assignee's (Magnify) SaaS platform;
Account—each such “customer” connects or integrates their respective CRM data with the SaaS platform built by the assignee, and manages their account or user lifecycles through the assignee's SaaS platform (in this sense, an account is a company or organization which uses a product or service provided by a customer of the assignee);
User—refers to an individual product or service user of an account;
Product—refers to software or a service provided by a customer of the assignee;
Journey—refers to a collection of actions (from the integrated platforms) that can be taken in sequence to assist a user and benefit a customer.

For example, if Boeing uses the Microsoft Excel software product, then Boeing is an account “owned” by Microsoft. Employees who work for Boeing and use Excel are users “owned” by Microsoft, where in this arrangement Microsoft is a customer of Magnify (the assignee of this disclosure).

As recognized by the inventors of the systems, methods, and devices disclosed and/or described herein, the technical and business challenges to addressing the currently encountered problems in maintaining a high level of customer satisfaction with software applications and services during the lifecycle of the usage of the software include one or more of the following:
a lack of homogeneity of potentially relevant data and fragmentation in where that data is located;
   this includes data stored in different formats, locations, and within different applications or services;
the diversity of the account or user business models and goals;
   this relates to the need to identify these models and goals, and how achieving those relate to use of the software application or service;
   this can also be relevant to determining when, how, and the type of information to present to an account or a user to increase the likelihood of achieving the user's goals and/or the goals of the provider of the software or service (where the provider may be represented by a presence on a SaaS platform operated by the assignee of the disclosure);
the diversity of learning approaches that may be used to identify and understand high value actions (HVAs);
   this relates to the types of models and techniques that may be used to evaluate data and “predict” user behavior, and/or to identify high value actions (HVAs) of a user that are more closely related to achieving a business' goals or objectives;
a need for sufficient explainability regarding customer account or users and their behavior metrics;
   this relates to a desire to explain to customers how best to achieve their desired business goals and/or to determine the factors responsible for account or user behaviors and interactions with a software application or service;
the variability of individual user behavior patterns and actions, and how those may impact outcomes;
   this emphasizes a need for personalized and user-specific recommendations and information or training; and
the need for development of a closed looped feedback model that includes the customer accounts or user and is operable across the lifecycle of actions, predictions, and outcomes related to or associated with a software application or service;
   this relates to the ability to automatically update and improve models and predictive processes so that they are evaluating or predicting based on current account or user actions.

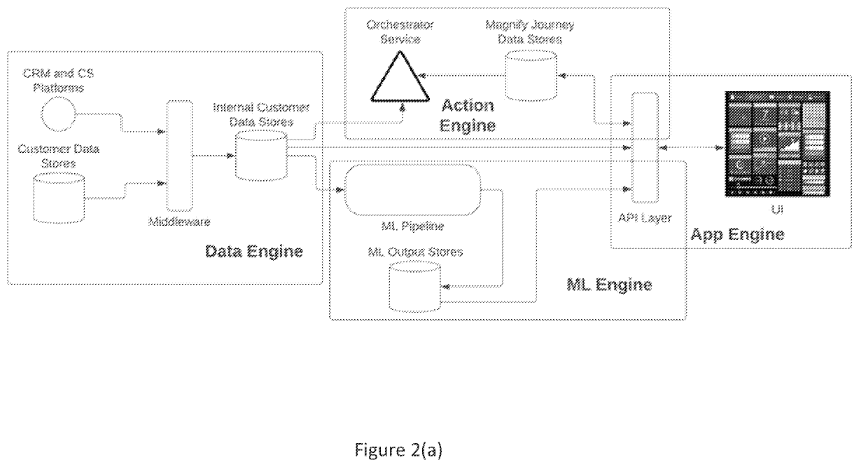

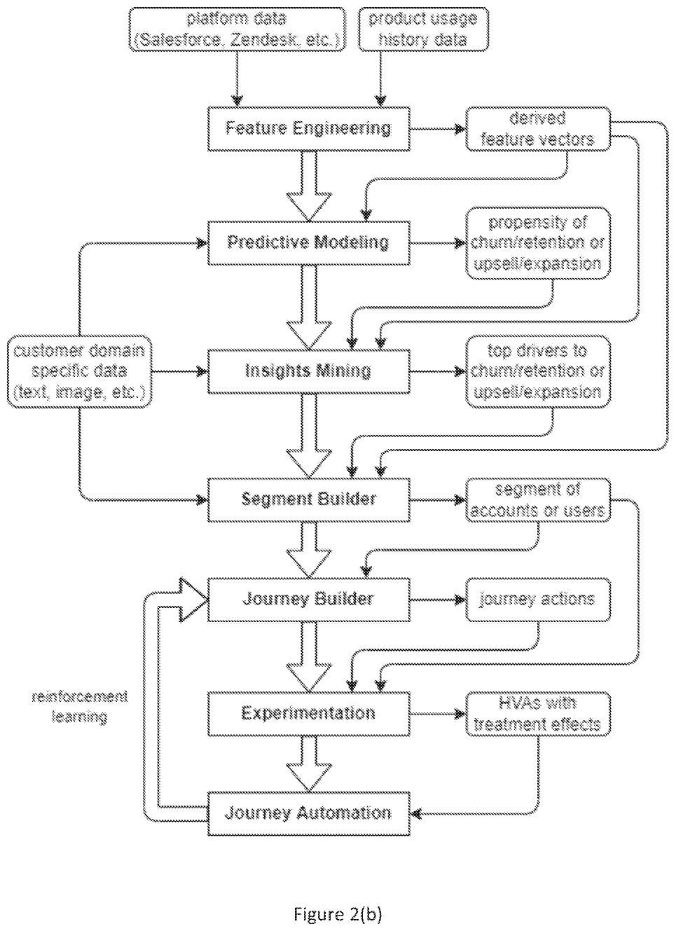

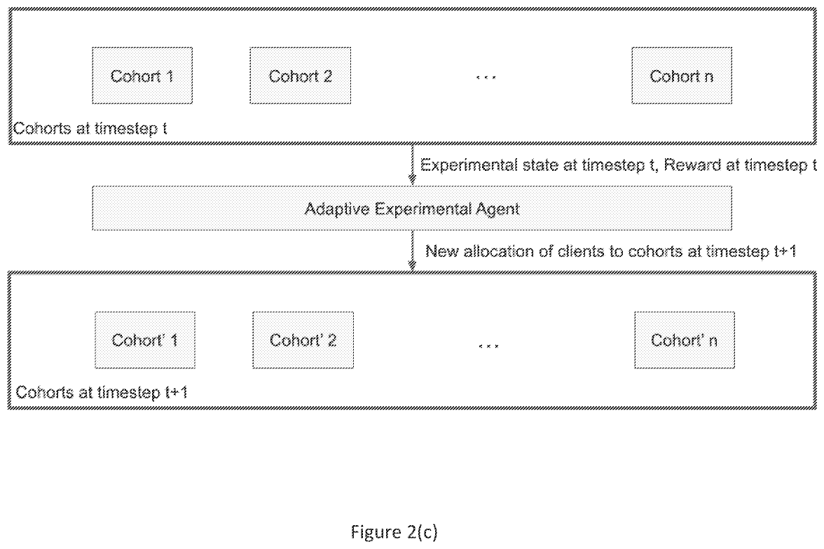

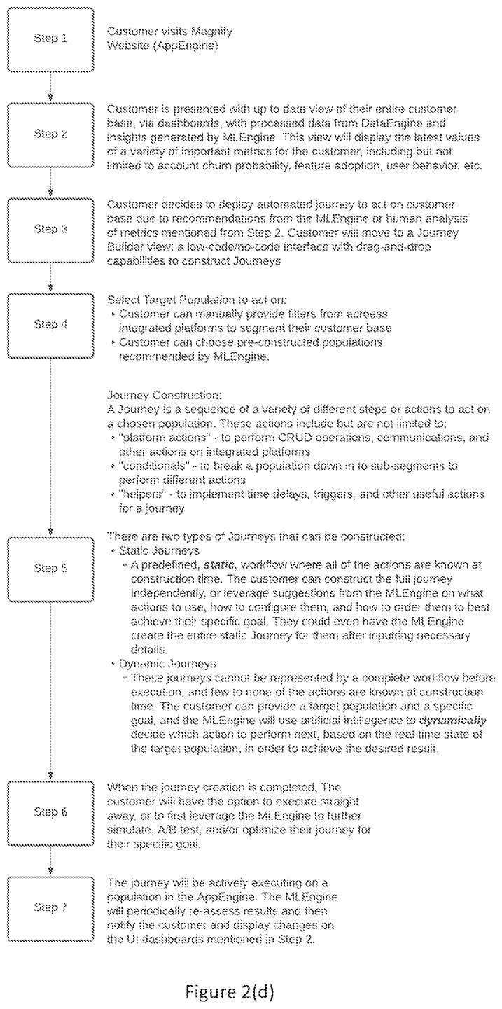

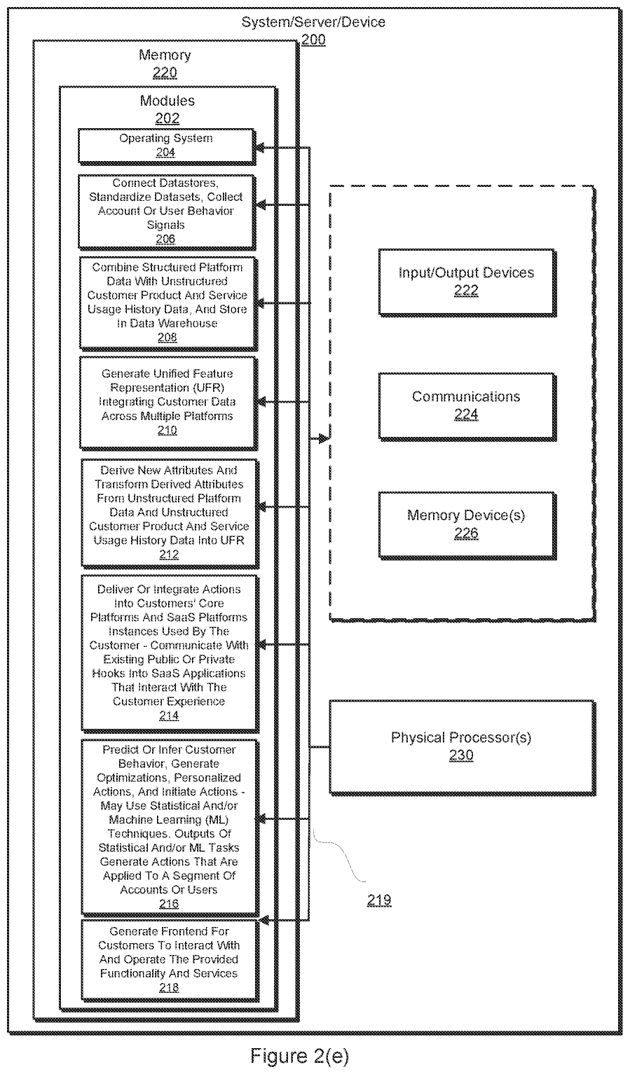

In one embodiment, the disclosed system (referred to as Magnify OS herein) has 4 primary subsystems (as illustrated in FIG. 2(a)) that cooperate to produce the described benefits. As a non-limiting example, these subsystems and associated processes may comprise:
Data Engine—systems and processes responsible for connecting to fragmented datastores, standardizing datasets, and collecting customer account or user behavior signals;
   In some embodiments, the disclosed system operates to extracts customer-account-user relationship data from one or more CRM platforms through data connectors. The disclosed system combines the structured platform data with unstructured customer product and service usage history data and stores it in the system's data warehouse;
      The disclosed system extracts common behavior attributes from customers, accounts, and users to form a Unified Feature Representation, which is utilized by the Action Engine, ML Engine, and App Engine, as described herein;
         In some embodiments, a Unified Feature Representation (UFR) integrates customer data across multiple platforms (Salesforce or Marketo, as non-limiting examples) and their objects (a Salesforce account table or opportunity table, as a non-limiting example) into a dedicated storage media (as non-limiting examples, AWS S3 or AWS Redshift) so that each account or user will have a feature vector with identical length;
         A feature vector, for example, may include recency, frequency, and/or monetary attributes such as the average provision time (in seconds) of an account over the last 30 days, days since the latest trouble ticket creation from an account, the distinct number of cloud instances a user created in last week, and total employee count of an account;
         Each feature in the feature vector may be evaluated for its predictive importance using ML models such as regression, classification, or correlation analysis. The most important features are the top drivers towards churn, expansion or service adoption;
         Since there is no guarantee that all table objects exist for all accounts or users, a UFR process may compose a feature vector of an account or a user by joining identifier fields (account name, email address, and/or and first and last names, as non-limiting examples) across platform objects dynamically, based on the availability of field values. Customer data may also be “noisy” due to different procedures used when ingesting records, and an embodiment of the UFR process may operate to clean up outliers and impute one or more missing values;
   The disclosed system may derive new attributes and transform the derived attributes from unstructured platform data and unstructured customer product and service usage history data into a format suitable for use with the UFR format. The derivation and/or transformation processing may leverage cloud computing services for a batch of account or user data jointly and on (or at) a specified cadence;
      For example, product usage history data typically includes feature usage history by account and is typically presented in a time series. In some example embodiments, performance of a machine learning model can be improved by including more information when training the model. In response to this possible source of improvement, the disclosed system may aggregate the total feature usage times within a time horizon (one week or one month, as non-limiting examples) of interest. In another example, given actual or projected revenue and cost in a feature usage history, the disclosed system may derive the contribution to profit margin from that data;
Action Engine—systems and processes responsible for orchestrating (i.e., delivering or integrating, as example functions) actions or recommendations into a customer's core platforms and/or SaaS platforms instances used by the customer;
   As a non-limiting example, Customer Service Representatives (CSRs) of the disclosed system's customers can identify account or user segments of interest through data mining based on one or more behavior attributes that the Data Engine incorporated. Representatives may initiate automated (i.e., not manual, or human-based) actions based on their domain knowledge and/or a recommendation generated by the disclosed ML Engine component or process;
      Actions that are applied will impact accounts and users through improving metrics of customer interest, and be used to update customers' CRM platform data;
   In some embodiments, the disclosed Action Engine is responsible for communicating with existing public or private hooks into SaaS applications (APIs or datastores, as non-limiting examples) that interact with the customer experience. The Action Engine intercepts activities recommended by the ML Engine or the Journey creator and then calls into the external hooks to perform or otherwise enable those activities;
Machine Learning (ML) Engine—systems and processes responsible for “predicting” customer account or user behavior, generating optimizations, personalizing actions, and initiating actions into the Action Engine;
   In some embodiments, the ML Engine component or process may use statistical and/or machine learning (ML) techniques to perform tasks related to generating inferences, predictions, and/or recommendations. The outputs of those ML tasks generate actions that are applied to a segment of accounts or users to achieve (or assist in achieving) a desired business goal;
   Embodiments of the disclosed system use an ML (in the form of a development life cycle) management pipeline to orchestrate model training, re-training, inference, and versioning through cloud computing services;
   Embodiments may be used to predict churn, expansion, and/or service adoption of a customer account or user based on their attribute(s). In one embodiment, the system separates prediction domains into consumption and subscription models to better understand a customer's business. When a new customer onboards, a trained model can be used to predict a likelihood of churn, expansion, and/or service adoption so that a CSR is able to receive an alert on accounts or users of interest or concern;
   The disclosed system may be used to segment accounts and/or users based on attributes which have the most causal impact on churns, expansions, or service adoptions. Customer Service Representatives (CSRs) can view these impactful attributes and apply actions to improve them to achieve a desired business goal;
   In some embodiments, the disclosed system may evaluate the effectiveness of actions using one or both of two approaches. These approaches are (1) causal inference of empirical actions service representatives have applied in the past, and (2) A/B testing actions applied on journeys (i.e., suggested, or recommended actions to encourage desired end-user behavior and discourage undesirable behavior). The system then recommends actions that are most likely to be effective to achieve a customer's business goals using reinforcement learning (RL);
      In one sense a journey is a set of rules organized (typically by a customer of the disclosed system) to target activities against a population of their own accounts or users based on specified criteria. The journeys are intended to assist in moving customers to a more optimal business state (i.e., one intended to assist in achieving a desired goal);
      FIG. 2(b) illustrates an example embodiment of the ML Engine and its processing flow (which is described in greater detail below);
App Engine—A frontend for customers of the disclosed system to interact with and operate the operating system (the Magnify OS)—among other functions, supports an ability to orchestrate actions via a “journey” into the Action Engine, gathers insights and actions taken on predictions from the ML Engine, and adds/removes data stores (sources) and platform integrations using the Data Engine.

With reference to the ML Engine illustration of FIG. 2(b), in some embodiments, the primary steps, stages, functions, operations, or processes and their respective inputs, outputs, and data processing may be described as:
Feature Engineering Service—operates or functions to derive “richer” signals to enhance the representation of account and user characteristics;
   Example Input(s):
      Standard objects (accounts, opportunities, or tasks, as examples) from platforms (Salesforce or Zendesk, as examples);
      Product usage history (e.g., feature usage amount);
      Account or user engagement history (sending email or setting up a meeting, examples);
   Example Output(s):
      Feature vectors containing values represented in one or more data types (as non-limiting examples, numeric, categories, or text) per account or user;
   Data Processing Techniques/Algorithms Applied (examples):
      Recency, frequency and monetary (RFM) features generation;
      Feature vectorization to transform text and image context into numeric feature vectors (embeddings or convolutions, for example);
      Feature generation based on domain knowledge; for example, generating econometrics, marketing, or financial metrics;
      Missing values may be imputed by population statistics (e.g., zero, min, max, mean, mode) or model predictions;
Predictive Modeling Service—operates or functions to “predict” the likelihood of achieving a customer business objective;
   Example Input(s):
      Generated feature vectors from Feature Engineering Service;
      Raw text or image data from customers;
   Example Output(s):
      Predicted objectives of customer interest, for example, likelihood of churn/retention or upsell/expansion opportunities;
   Data Processing Techniques/Algorithms Applied (examples):
      Machine Learning (ML) algorithms include supervised (regression or classification, as non-limiting examples) or unsupervised (clustering or associated rules, as non-limiting examples);
Insights Mining Service—operates or functions to measure and demonstrate the factors that impact account or user characteristics and/or recommend actions customers can take on their accounts or users;
   Example Input(s):
      Generated feature vectors from Feature Engineering Service;
      Raw text or image data from customers;
      Predicted objectives of customer interest, for example, likelihood of churn/retention or upsell/expansion opportunities;
   Example Output(s);
      Top “drivers” which are most likely to lead accounts or users to achieve customer objectives;
   Data Processing Techniques/Algorithms Applied (examples):
      Model explanation algorithms (e.g., Accumulated Local Effect) to explain the contribution of modeling features or actions towards achieving customer objectives;
      Feature-wise clustering algorithms (centroid-based, density-based, or hierarchical, as non-limiting examples) to group highly correlated features into composite driver groups;
Segment Builder—operates or functions to identify, or help customers to identify segments of accounts or users to apply actions to;
   Example Input(s):
      Account or user attributes;
      Customer objectives (e.g., reduce churn (increase retention) or upsell (expansion of products or services provided to accounts);
      Customer-specified prototypes of accounts or users according to their empirical understandings;
   Example Output(s):
      A segment of accounts or users under the same filtering criteria, or with similar attributes;
   Data Processing Techniques/Algorithms Applied (examples):
      Accounts or users can be selected through a sequence of conditional filters;
      Clustering algorithms (centroid-based, density-based, or hierarchical, as non-limiting examples) to group accounts or users with similar attributes into a segment;
      Probabilistic modeling algorithms (classification, as an example) to match accounts or users with customer-specified prototypes of accounts or users;
Journey Builder—operates or functions to chain actions and apply these actions to a selection of accounts or users;
   Example Input(s):
      Segment of accounts or users;
      A group of eligible actions the customer can apply to the segment of accounts or users;
   Example Output(s):
      A suggested workflow with one or more of filters, decision making, conditions, and/or looping components for actions that may be orchestrated into one or multiple software systems that interact between customers and accounts/users (e.g., email, messaging, or product experience applications, as non-limiting examples);
Experimentation Service—operates or functions to measure the effectiveness of a journey and/or it actions;
   Example Input(s):
      Segment of accounts or users to which a journey will be applied;
      The definition of the journey and actions to execute within the journey;
   Example Output(s):
      Effectiveness of a journey and/or its actions;
   Data Processing Techniques/Algorithms Applied (examples):
      Randomized experiments, for example, A/B testing;
      Adaptive experiments;
      Causal inference with machine learning algorithms;
Journey Automation Service—operates or functions to execute journey actions to achieve a customer business objective automatically (i.e., without human interaction):
   Example Input(s):
      Accounts or users selected by a journey;
      Actions with their values from prior experiment results;
   Example Output(s):
      The Journey Automation Service will assign candidate actions to accounts or users corresponding to action values, until a customer objective is achieved;
   Data Processing Techniques/Algorithms Applied (examples):
      Reinforcement learning and/or dynamic programming.

In some embodiments, the disclosed system or platform can access, combine, and analyze customer account and user behavior from multiple data sources, ranging from domain specific datastores to SaaS applications. This data includes customer revenue and their account or user purchasing behavior, product usage and related telemetry and signals, support request and incidents from end-users, marketing, and communication engagement data, as well as other data sources.

In some embodiments, the disclosed system or platform may do this by “pulling” data via standard authentication processes into datastores from SaaS applications accessed by a customer of the platform and its authorized individuals and normalize relevant data into standardized formats or datasets. The system or platform then organizes the data and the relationships to make it agonistic to the ML Engine (i.e., in terms of data features). This allows the ML Engine to be able to “predict” or classify similar business outcomes based on use of disparate data sources.

An example of this capability is the following situation. A credit card company thinks of usage of their product as the number of times users have swiped their credit card and they collect this data daily. A cloud service provider may look at usage of their product as the number of services their users' access, and that is tracked monthly. Embodiments of the disclosed system will normalize this data on a consistent timescale and map the result to the same feature set, for example the one used by a ML model that “predicts” churn. Another example is where a collected metric has a specific format or unit (such as a percent, basis points, or an absolute number) and/or is measured over different timescales and the data needs to be normalized to be used effectively.

Embodiments of the disclosed system train its optimization and other models using previous orchestrations (i.e., actions, processes, or decisions) performed by a customer to identify high value actions (HVAs). HVAs are actions that have a higher likelihood of generating the “best” outcomes with regards to achieving the customer's business objectives (such as by encouraging the desired behavior by end-users). The system may use training data provided by customers, including “ideal” customers and preferred behaviors, to identify HVAs. As an example, if a customer provides an engagement dataset, which records actions the customer has taken on each account or user in the past (sending emails or setting up business review meetings, as examples), then the disclosed system will evaluate the effectiveness of these actions to achieve the objective or goal of interest.

Embodiments of the disclosed system may use a Causal Machine Learning model to mine/identify High Value Actions which have the greatest likelihood of improving revenue or reducing churn (or operate to do so to the greatest extent). Using reinforcement learning algorithms, the system updates action rewards to be the value of the “best” HVA(s) a customer service representative can take for a segment of end-users or use cases of interest.

After applying an action or actions, customer accounts or users may migrate across segments, so that the system can determine the best actions for each segment dynamically. The system can determine the best HVAs a representative can take for each segment to achieve (or increase the probability of achieving) the desired goal(s), such as to reduce churn, expand business, or increase service adoption as non-limiting examples. If a Customer Service Representative (CSR) consents to automatically execute the best HVAs, the system can orchestrate the entire process “touch-free” (i.e., without requiring manual or human intervention by the CSR).

The system's customers and/or authorized individuals may permit the operator of the disclosed system or platform to optimize HVAs across their own account or customer base. The system can also determine which HVAs will have impact for specific accounts or users, allowing for personalization and customization of proposed actions and communications strategies to software users.

In one embodiment, the general form of the data processing flow and associated logic implemented as part of the disclosed system or platform and associated methods may comprise:
Elements, components, and processes for connecting fragmented datastores, standardizing datasets, and collecting account or user behavior signals;
   extracting customer-account-user relationship data from one or more CRM platforms (as a non-limiting example) through data connectors, combining the structured platform data with unstructured customer product and service usage history data, and storing it in the system's data warehouse;
      this may include keystrokes, entered data, entered alphanumeric strings, signals generated by a software application, an instruction or command executed by a software application or service, an event generated in response to a signal, user input, or other event, as non-limiting examples;
      A customer uses a CRM platform (Salesforce as an examples) and/or telemetry database (Snowflake as an example) to collect their account information and engagement history. The account's engagement history may contain more granular user-level engagements along with the account itself. For example, if Microsoft is a customer of the assignee (Magnify), it may record their account (Boeing as an example) information (company size, establishment year) in a Salesforce “Account” object, along with product usage (Excel as an example) of Boeing's employees;
         When Microsoft uses the assignee's SaaS platform to manage their account lifecycle, it provides streaming permissions for their CRM platforms to allow the SaaS platform to access their account and user information;
Generating a Unified Feature Representation (UFR) integrating customer data across multiple platforms;
   optionally, derive new attributes and transform the derived attributes from unstructured platform data and unstructured customer product and service usage history data, as disclosed and/or described herein;
      as a non-limiting example, customers of a subscription business or a consumption business may store revenues in different formats. For example, a subscription business customer may track revenue by the contract values of its accounts, while a consumption business customer may track revenue per service product usage. In this example, the UFR amortizes their revenues into daily, monthly or annual recurring revenues so that expansion or churn events can be derived through the increase or decrease of amortized revenue;
Elements, components, and processes responsible for orchestrating (delivering or integrating) actions into customers' core platforms and SaaS platforms instances used by the customer, by communicating with existing public or private hooks into SaaS applications (APIs or datastores, as examples) that interact with the customer or user experience;
Elements, components, and processes responsible for “predicting” or inferring customer account or user behavior, generating optimizations, personalizing actions, and initiating actions—in some embodiments, these may use statistical and/or machine learning (ML) techniques to perform tasks related to generating inferences, predictions, and/or recommendations. The outputs of those ML tasks generate actions that are applied to a segment of accounts or users to achieve (or assist in achieving) a desired business goal;
   training data and data used in a prediction or inference process may include (as non-limiting examples) revenue, profit, sales, expenses, business plans, specific KPIs, or generated user inputs;
   the predicted results will help identify an optimal segment of accounts or users to target, on which customers (such as organizations that use a software program) can take actions to achieve the business goals;
   in one embodiment, an input to these models is a combination of preprocessed features along with raw data, for example, raw text email dialogues extracted from a CRM integration. Preprocessed features capture variables that are expected to be relevant for a large portion of customers, though there will typically be customer-specific variations that are difficult to anticipate with precomputed features. The disclosed and/described models will accept raw text and images as input along with the numeric features, so that the modeling pipelines can incorporate domain-specific knowledge to address unexpected customer-specific variations before analyzing the data;
   Machine Learning algorithms are instantiated within pipelines and hyperparameters are tuned automatically. The pipelines also perform model selection across a collection of different models based on evaluation metrics. Each pipeline instance is trained using the data from a sample of accounts or users and may be across multiple customers; training is concluded once each candidate model has been trained and the optimal model for a given sample of accounts or users has been selected;
   in some embodiments, features or model inputs may be identified or determined by one or more of:
      correlation coefficients between initial and subsequent sets or categories of business data to determine the most highly correlated operational features (e.g., aspects, KPIs, or other metrics);
         for example, development of a ruleset formed from the outcome of a statistical analysis;
      a derived formula involving weighted features and based on a “best” fit of data to expected behavior;
      output of a model trained to generate N features from a much larger set of input features, where the N features are those most responsible for the model output (such as by being most highly correlated with an output, based on a sensitivity or other form of analysis);
      in one embodiment, the model generated (or otherwise obtained) outputs (or in some cases the features) are the acceptable goal or goals of a business—these represent desirable endpoints to either maximize or optimize in conjunction with other features;
   using feature engineering techniques to derive “richer” signals to enhance the representation of relationships from collected platform data and product usage history;
      recency, frequency and monetary (RFM) features during specified horizons (for example, 7-day, 30-day, 90-day) may be generated with distributed large-scale data processing tools;
      feature vectorization can be applied to transform text and image content into numerical feature vectors;
      missing values may be observed because of noisy platform data, product usage history, or emerging accounts or users—in one embodiment, missing values may be imputed by population statistics;
Elements, components, and processes to generate a frontend for customers and authorized individuals of the disclosed system to interact with and operate the provided functionality and services—among other functions, supports an ability to orchestrate actions via a “journey”, gathers insights and actions taken on predictions, and add/remove data stores (sources) and platform integrations.

In some embodiments, the disclosed and/or described system and methods may be used to predict, infer, or estimate a likelihood of churn or retention, an upsell opportunity, or expansion of a user base, as non-limiting examples. The predictive models can be established based on a classification algorithm as well as ensemble combinations. In one embodiment, to enhance prediction heterogeneity in customer domains, models may be trained per segment of customers, for example, by business type (consumption versus subscription), industry (retail, education, or healthcare, as examples), or based on individual customers and/or their characteristics.

As disclosed and/or described, embodiments may use machine learning algorithms to cluster customer accounts or user(s) segments. Customers can then apply what are termed herein as “journey” actions to segments of interest to achieve a business goal or goals:
In some embodiments, cluster analysis algorithms or association rules may be used to group similar accounts or end-users together by comparing their behavior attributes (e.g., as generated by a feature engineering service). For example, a segment of accounts or users can be created based on leading predictive indicators towards a business goal of interest to a customer;
In one embodiment, these algorithms can be specific instances of the disclosed and/or described machine learning pipelines. This implies that their inputs are similar and may include a combination of precomputed features along with raw data. In addition, the automated process of model training and model selection may be used on these models;
Statistical and/or machine learning algorithms may be used to measure the effectiveness of actions customers took on segments of accounts or users;
   for example, randomized “experiments” can be applied to examine the impact of various actions, options, decisions, or treatments. Accounts or users may be divided into groups at random, and a collection of actions (or options, decisions, or treatments) applied to each group (where a different collection of actions may be applied to each group). After a predetermined period, the “experiment” is concluded and the effects of the experiment on each group are analyzed.

In one embodiment, A/B testing may be implemented to let a customer break down a segment of accounts or end-users from a journey into a treatment group and a control group; for example, with 90% of accounts identified as treatments and 10% of accounts as controls. The customer then applies actions to try to achieve a business goal. The treatment effect or impact can be measured through statistical tests in a way that a significant difference of outcomes between treatment and control groups indicates a positive or negative effect towards achieving the desired business goal.

In one embodiment, adaptive and continual learning “experiments” may be applied to measure treatment impact and effects. Accounts or users may be divided into groups before the experiment is begun, but unlike in randomized control experiments, the collection of actions applied to each group may change during the experiment. The change may be made to optimize an objective, for example, to reduce churn. Unlike randomized experiments, because some subset of accounts or users is not at risk of being exposed to a sub-optimal collection of actions, adaptive experiments may not end naturally and may require a termination point to assess the results or benefits;
In one embodiment, a customer can break down a segment of accounts or users from a journey into two groups, each exposed to a different collection of actions (an email campaign and a sequence of phone calls, as an example). When the experiment is initiated, each collection of actions is applied to its respective group and at predetermined intervals, the performance of each group is analyzed based on an objective (e.g., the average churn of the group). Accounts or users can be moved between groups using reinforcement learning until the movement of accounts or users between groups converges to zero or settles and little (if any) further progress can be identified.

Causal inference is an approach that addresses questions that randomized experiments are not able to answer in counterfactual statements or are not applicable because of statutes or regulations concerning data privacy. For example, under some non-discrimination regulations, customers may not be able to separate their accounts into treatments and controls. In such a situation, causal inference addresses the question, “What if an account or a user had or had not been treated before?”. Implementation of such an approach is described in greater detail as part of this disclosure.

When customers of the disclosed system or platform onboard product usage data to the system or platform, they are interested in knowing how accounts and end-users (e.g., employees of the customer) engaged with a product in the past, and the treatment actions that already were applied. In this situation, the disclosed system or platform may propose high(er) value actions (HVAs) after estimating one or more HVAs from what has happened before with a set of users;
Since customers were not likely to be randomly assigned to treatment or control groups in the past, a simple difference in outcomes fails to reveal true treatment effects and is usually overestimated due to selection bias. Causal inference utilizing ML algorithms may be employed to correct the selection bias within a non-randomized environment. In some embodiments, causal machine learning techniques, for example, Robin's causal framework or Double/Debiased Machine Learning may be employed to estimate the average or heterogeneous effect of a treatment;
Actions which are most effective to help achieve business goals are defined as HVAs. In one embodiment, the effectiveness of an HVA is estimated with confidence intervals, for example, through bootstrapping. If the lower bound of a confidence interval is above 0, then the HVA is identified as a positive-value action (PVA). If the upper bound of the confidence interval is below 0, then the HVA is identified as a negative-value action (NVA). If the confidence interval extends across 0, then the effectiveness of the HVA is not statistically significant. The larger an HVA value is, the more likely it is significant in achieving a customer objective.

Adaptive Experiment Service is an approach that may be implemented as part of the disclosed and/or described system and is different from a traditional A/B test, which investigates the effectiveness of one action. An adaptive experiment measures the optimal action(s) a customer can take among several possibilities. A journey (in the sense used herein) sometimes contains more than two actions, and an adaptive experiment can help customers prune redundant actions and simplify the journey workflow;
Adaptive experimentation begins with the allocation of accounts to cohorts (as suggested by FIG. 2(c), which is a diagram illustrating an embodiment of the adaptive experimentation capability that may be implemented as part of an embodiment of the disclosure). Each cohort implies the application of a journey or set of actions. In one embodiment, at each experiment session, an Adaptive Experimental Agent accepts the treatment actions (e.g., sending a promotion email or setting up a business review meeting) and the effectiveness of these actions observed from the previous experiment session as inputs. Before each experiment treatment, cohorts may be rebalanced using stratified sampling approaches (e.g., Horvitz-Thompson Sampling). The process of iterative rebalancing of treatment cohorts may continue indefinitely, or it may be stopped, for example, when an acceptable treatment effect threshold is reached.

After identifying a suitable HVA and account or accounts, in some embodiments, the system or platform operates to enable execution of a “journey” to achieve a desired business goal. Journeys can be executed by customers through receiving recommendations of an action, or may be executed/performed in an automated manner;
In one embodiment, to measure or assess an action's “quality”, the disclosed system defines quality to represent the expected future reward of an action. This definition of quality is referred to as a Q-Value (a term taken from the reinforcement learning (RL) community). The reward can be defined in different ways depending on the customer's ultimate objective. For example, one possible reward is the average churn across a segment of end-users or accounts;
In some situations of recommending actions that optimize the Q-Value, the selected reward may be difficult to optimize, with some system customers making little or no progress. For example, this may be the case with reducing churn: many companies fail to develop a successful strategy for optimizing churn. In some embodiments, the disclosed system or platform may use a technique known as “reward shaping” that involves introducing intermediate rewards that are easier for customers/companies to achieve and allows them to make progress towards the goal (e.g., that of reducing churn or reducing it by a desired amount);
   one example of an intermediate reward may be the response rate for completion of a net promoter score (NPS) survey. In many cases, it is easier to get an account or user to respond to an NPS survey than it is to reduce churn (e.g., one can pay them to complete a survey). Using this approach, customers may increase the volume of feedback they are collecting from their accounts or users and reduce the sparseness of the data related to the goal or reward, that of reducing churn (as an example).

In one embodiment of a process for recommending an action or actions, an HVA or HVAs with top treatment effects can be recommended to customers to execute on a journey. In one embodiment of automation, reinforcement learning and/or dynamic programming techniques may be applied to help customers refine their path to achieve business goals. For example, using reinforcement learning, a state can be defined using a collection of account or user attributes (e.g., feature usage across the customer platform), an action can be an HVA, and the reward can be defined as the average churn across a segment of accounts specified by the journey. Further, the Q-Values can be defined using shaped rewards and may be further updated based on randomized online experiments.

In some embodiments, the disclosed system and processes may operate to encourage customers to generate a desired set of events or incentivize desired account or user behavior(s);
Using output(s) of one or more trained models (and data and information regarding specific interactions with software or a service), the disclosed system may generate a sequence including suggested timing and substance of one or more of actions, communications, information, hints, or events to present to customers (i.e., to accounts and/or users);
   can incorporate a determined sequence with other information about a user;
      this may include information about one or more of their experience level with a software application, their experience in a current job function, their recent health, or their recent attendance or performance at work, as non-limiting examples;
   one or more of these functions or capabilities may be performed by the Action Engine component, element, or process disclosed herein;
      in some embodiments, the Journey referred to herein may provide suggestions or guidelines for how to encourage a desired behavior.

The disclosed system or platform then presents the recommended actions to accounts or users and detects their response(s). Depending upon the form of encouragement, the presentation and/or detection of a response may include one or more of;
Through direct communication (email, text, or phone);
By presenting specific content;
Participation in a meeting;
Gamification of an activity or task;
Detection and processing of a response received from an account or user;
   the response may be in the form of keystrokes, data inputs, or events generated after a user action.

An incentive offered to a user may be tuned to be compelling enough to entice users to listen (i.e., to be receptive) to a suggestion, but not powerful enough to overwhelm or supersede their domain knowledge about the best action for their company at the time of presentation;
For example, in the case of a cash reward for listening to a suggestion, the cash reward is chosen to be significant relative to market prices for common goods, but not so large as to dwarf the salary of the recipient. In the latter case, users may follow a suggestion that is not in their employer's best interest. This scenario will provide incorrect feedback to the system about HVA's as well as harm the system's customer;

The system also operates to determine if the received response, data, and/or inputs represent satisfactory progress towards improving the likelihood of achieving a goal;
If so, the system ends presentation of the determined sequence;
   if not, then continue presentation of the determined sequence, initiate a new cycle of presentation, or request specific information (as needed) to make progress towards the business goal(s);
   where one or more of these functions or capabilities may be performed by the App Engine component, element, or process disclosed herein.

As a non-limiting example, FIG. 2(d), is a diagram illustrating an example of the customer/account experience when an authorized individual (such as a customer of the disclosed system or platform, which may be a business or software developer, as non-limiting examples) interacts with an embodiment of the disclosed system or platform, and the associated functions and capabilities. FIG. 2(d) illustrates how an embodiment provides customers with an up-to-date view of their own customer base, including non-trivial customer insights and forecasts generated by the disclosed processes, which will help support them in making the most well-informed decisions and action plans in their customer success operations. FIG. 2(d) also illustrates how an embodiment provides customers of the disclosed system or platform with a low-code/no-code interface to build customer success journeys that will perform actions in an automated matter, at a large scale, which vastly improves and simplifies any manual or conventional customer success tasks. Embodiments also provide customers of the system with the option to incorporate ML recommendations in their customer success journeys to leverage both qualitative and quantitative factors to determine the best actions to perform on their own customers.

FIG. 1(b) is a flowchart or flow diagram illustrating a method, process, operation, or set of functions 100 that may be used in implementing an embodiment of the disclosure. The set of steps or stages illustrated in FIG. 1(b) represent an example of a process for acquiring data from multiple sources, generating a unified data representation, operating machine learning or other models to predict or infer account or user behavior, and in response generating a sequence of actions or behaviors to assist an organization in achieving a business goal:
A process or service to connect fragmented datastores, standardize datasets, and collect account and/or user behavior signals (as suggested by step or stage 102);
   This may include extracting customer-account-user relationship data from one or more CRM platforms through data connectors, combining the structured platform data with unstructured customer product and service usage history data, and storing it in the disclosed system's data warehouse;
A process or service to generate a Unified Feature Representation (UFR) integrating customer data across multiple platforms (as suggested by step or stage 104);
   This may include deriving new attributes and transforming the derived attributes into the unified feature representation from unstructured platform data and/or unstructured customer product and service usage history data;
      as a non-limiting example, customers of a subscription business or a consumption business may store revenues in different formats. For example, a subscription business customer may track revenue by the contract values of its accounts, while a consumption business customer may track revenue per service product usage. In this example, the UFR amortizes their revenues into daily, monthly or annual recurring revenues so that expansion or churn events can be derived through the increase or decrease of amortized revenue;
      as another example, product usage history data typically includes feature usage history by account and is typically presented in a time series. In some example embodiments, performance of a machine learning model can be improved by including more information when training the model. In response to this possible source of improvement, the disclosed system may aggregate the total feature usage times within a time horizon (7-day or 30-day, as non-limiting examples) of interest. In another example, given actual or projected revenue and cost in a feature usage history, the disclosed system may derive the contribution to profit margin from that data;
A process or service to orchestrate (deliver or integrate) actions (such as recommendations, activities, or events, as non-limiting examples) into customers' core platforms and SaaS platforms instances used by the customer, in some cases by communicating with existing public or private hooks into SaaS applications (APIs or datastores, as examples) that interact with the customer experience. This may include providing email or other forms of communication, in-product tutorials, product announcements and alerts, and other potential interactions, as non-limiting examples, as suggested by step or stage 106;
A process or service to “predict” account or user behavior, generate optimal actions or events, personalize actions, and initiate actions intended to assist in achieving an organization's business goals (as suggested by step or stage 108);
   In some embodiments, this process may include use of statistical and/or machine learning (ML) techniques to perform tasks related to generating inferences, predictions, or recommendations (as examples). The outputs of the statistical and/or machine learning (ML) tasks generate actions that are applied to a segment of accounts or users to assist in achieving a desired business goal. In some embodiments, this set of processes may comprise one or more of the following:
      Feature Engineering Service—operates or functions to derive “richer” signals to enhance the representation of account and/or user characteristics;
      Predictive Modeling Service—operates or functions to “predict” the likelihood of achieving a specific customer business objective;
      Insights Mining Service—operates or functions to measure and demonstrate one or more factors that impact account or user characteristics and/or recommend actions customers can take with regards to accounts or users;
      Segment Builder Service—operates or functions to identify, or help customers to identify segments of accounts or users to apply actions to;
      Journey Builder—operates or functions to combine or arrange actions and apply these actions to a selection of accounts or users;
      Experimentation Service—operates or functions to measure the effectiveness of a journey and/or its constituent actions; and
      Journey Automation Service—operates or functions to execute journey actions to achieve a customer business objective automatically (if desired, and without human interaction); and
A process or service to generate a frontend for customers (such as a business or organization, as non-limiting examples) of the disclosed system to interact with and operate the provided functionality and services. Among other functions, supports an ability to orchestrate actions via a “journey”, gathers insights and actions taken on predictions, and adds/removes data stores (sources) and manages platform integrations.

FIG. 1(c) is a flowchart or flow diagram illustrating a method, process, operation, or set of functions that may be used in implementing an embodiment of the disclosure. FIG. 1(c) presents certain of the functions or processes illustrated in FIG. 1(b) from a different perspective or order by indicating how the collected data and information may be used to determine (a) the goals of an account, (b) the relationship between software application or service events and achievement of a goal, (c) the relationship between user behaviors and the occurrence of a desired software application or service event, and (d) what information or experiences to present to a user to encourage the user to behave in a manner that will be likely to result in the desired event, and hence increase the likelihood of achieving a business goal or goals.

As shown in the figure, at step or stage 120, one or more business goals of a customer or account are identified. These may include but are not limited to (or required to include) increased revenue, increased profit, increased deal flow, improved employee retention, or decreased IT tickets, as non-limiting examples.

Next, at step or stage 122, the process identifies software application or service events that are strongly correlated with achieving a business goal or increasing the likelihood of achieving a business goal. These may include but are not limited to (or required to include) use of certain application functions or execution of a specific set of actions, as non-limiting examples. The identified software application or service events may be determined by statistical analysis and/or use of a trained model, as non-limiting examples.

Another aspect of the overall process flow is the collection of data regarding user behaviors and interactions with a software application or service, as suggested by step or stage 130. The data may include but is not limited to (or required to include) signals, inputs, keystrokes, application state data, or events generated by an application or service (or operating system in some cases). A model and/or statistical analysis may then be used to enable a “prediction” or inference of the likelihood of an identified event occurring based on user behaviors and interactions, as suggested by step or stage 132. The model may be trained using anonymized data representing the interactions between one or more users and a software application or service.

As a non-limiting example, a customer uses a CRM platform (Salesforce as an example) and/or telemetry database (Snowflake as an example) to collect their account information and engagement history. The account's engagement history may contain more granular user-level engagements along with the account itself. For example, if Microsoft is a customer of the assignee (Magnify), it may record their account (Boeing as an example) information (company size, establishment year) in a Salesforce “Account” object, along with product usage (Excel as an example) of Boeing's employees. When Microsoft uses the assignee's SaaS platform to manage their account lifecycle, it provides streaming permissions for their CRM platforms to allow the SaaS platform to access their account and user information.

If not already available from the trained model or statistical analysis, the user behaviors or actions that it is desired to encourage are then determined, as suggested by step or stage 134. These are the actions or behaviors that are strongly correlated with the occurrence of a desired event, and hence are expected to assist in the achievement of a goal.

Next, a business goal that it is desired to achieve (or to increase the likelihood of being achieved) is selected, as suggested by step or stage 136. This enables a determination of the software application or service events that are desirable to encourage, and from those, the user behaviors or actions to encourage to cause those software application or service events to occur. Based on the user behaviors or actions it is desired to encourage, the process flow then determines one or more items of information, training, or experience to present to a user or users, and the order and timing of the presented information, training, or experiences to encourage the user or users to generate the desired software application or service event(s), as suggested by step or stage 138. As non-limiting examples, the sequencing and/or timing may be determined by one or more of a trained model, statistical analysis, or evaluation of previous user behavior that resulted in the desired event;
In one embodiment, an event prediction service to predict the likelihood of churn and expansion events for all accounts may be used to generate predictions on a regular cadence (daily, weekly, or monthly). The predictions track whether the churn risk has decreased, or expansion opportunity has increased over time. If not, the customer can keep executing actions through journey services, as suggested by step or stage 142;
In another embodiment, a forecasting service to forecast product feature usage and revenue for all accounts may be used to generate forecasts on a regular cadence (daily, weekly, or monthly). The forecasts track whether the desired revenue goal has been reached by each account over time. If not, the customer can keep executing actions through journey services, as suggested by step or stage 142.

Next, the process flow presents the determined information, training, or experiences to a user or users, as suggested by step or stage 140. This may be followed by determining if the desired event occurred (as suggested by step or stage 142). If the desired event did not occur (as indicated by the “No” branch of step or stage 142), then the information, training, or experience presented to the user or users may be altered with regards to sequence, timing, or the items presented. If the desired event did occur (as indicated by the “Yes” branch of step or stage 142), then the process flow may continue to another process;
In one embodiment, a journey has been running for a long period of time, for example, three months but no statistical significance of churn reduction or expansion event is observed—in this situation the customer can alter the actions in the journey definition to engage with its accounts in a different way. Once the journey definition is updated, a new sequence, which is suggested by steps or stages 138, 140 and 142 will be resumed;
   When the “Yes” branch of step or stage 142 has been reached, it is assumed that the churn reduction or expansion goal has been achieved by the accounts of the customer. The customer can choose to stop the journey sequence for the accounts or users of interest.

FIG. 2(e) is a diagram illustrating elements or components that may be present in a computing device, server, or system 200 configured to implement a method, process, function, or operation in accordance with some embodiments. As noted, in some embodiments, the described system and methods may be implemented in the form of an apparatus that includes a processing element and a set of executable instructions. The executable instructions may be part of a software application and arranged into a software architecture.

In general, an embodiment of the disclosure may be implemented using a set of software instructions that are executed by a suitably programmed processing element (such as a GPU, TPU, CPU, microprocessor, processor, controller, state machine, or computing device, as non-limiting examples). In a complex application or system such instructions are typically arranged into “modules” with each such module typically performing a specific task, process, function, or operation. The entire set of modules may be controlled or coordinated in their operation by an operating system (OS) or other form of organizational platform.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

As shown in FIG. 2, system 200 may represent a server or other form of computing or data processing device. Modules 202 each contain a set of executable instructions, where when the set of instructions is executed by a suitable electronic processor (such as that indicated in the figure by “Physical Processor(s) 230”), system (or server or device) 200 operates to perform a specific process, operation, function, or method. Modules 202 may contain one or more sets of instructions for performing a method or function described with reference to the Figures, and the disclosure and/or descriptions of the functions and operations provided herein. These modules may include those illustrated but may also include a greater number or fewer number than those illustrated. Further, the modules and the set of computer-executable instructions that are contained in the modules may be executed by the same processor or by more than a single processor.

Modules 202 are stored in a memory 220, which typically includes an Operating System module 204 that contains instructions used (among other functions) to access and control the execution of the instructions contained in other modules. The modules 202 in memory 220 are accessed for purposes of transferring data and executing instructions by use of a “bus” or communications line 219, which also serves to permit processor(s) 230 to communicate with the modules for purposes of accessing and executing a set of instructions. Bus or communications line 219 also permits processor(s) 230 to interact with other elements of system 200, such as input or output devices 222, communications elements 224 for exchanging data and information with devices external to system 200, and additional memory devices 226.

Each application module or sub-module may correspond to a specific function, method, process, or operation that is implemented by the module or sub-module. Each module or sub-module may contain a set of computer-executable instructions that when executed by a programmed processor or co-processors cause the processor or co-processors (or a device or devices in which they are contained) to perform the specific function, method, process, or operation. Such function, method, process, or operation may include those used to implement one or more aspects of the disclosed system and methods, such as to:
Connect Datastores, Standardize Datasets, Collect Account or User Behavior Signals (as suggested by module 206);
Combine Structured Platform Data with Unstructured Customer Product and Service Usage History Data, and Store in Data Warehouse (module 208);
Generate a Unified Feature Representation (UFR) Integrating Customer Data Across Multiple Platforms (module 210);
Derive New Attributes and Transform Derived Attributes from Unstructured Platform Data and Unstructured Customer Product and Service Usage History Data into the Unified Feature Representation (module 212);
Deliver or Integrate Actions into Customers' Core Platforms and SaaS Platforms Instances Used by the Customer—Communicate with Existing Public or Private Hooks into SaaS Applications that Interact with the Customer Experience (module 214);
Predict or Infer Customer Behavior, Generate Optimizations, Personalized Actions, and Initiate Actions—May Use Statistical and/or Machine Learning (ML) Techniques to Perform Tasks Related to Generating Inferences, Predictions, or Recommendations. Outputs of Statistical and/or Machine Learning (ML) Tasks Generate Actions That Are Applied to a Segment of Accounts or Users to Achieve a Desired Business Goal (module 216); and
Generate Frontend for Customers to Interact with and Operate the Provided Functionality and Services—Support Ability to Orchestrate Actions, Gather Insights and Actions Taken on Predictions, and Add/Remove Data Stores and Manage Platform Integrations (module 218).

As mentioned, each module may contain instructions which when executed (in whole or in part) by a programmed processor cause an apparatus (such as a server or client device) to perform the specific function or functions. The apparatus may be one or both of a client device or a remote server or platform. Therefore, a module may contain instructions that are performed (in whole or in part) by the client device, the server or platform, or both.

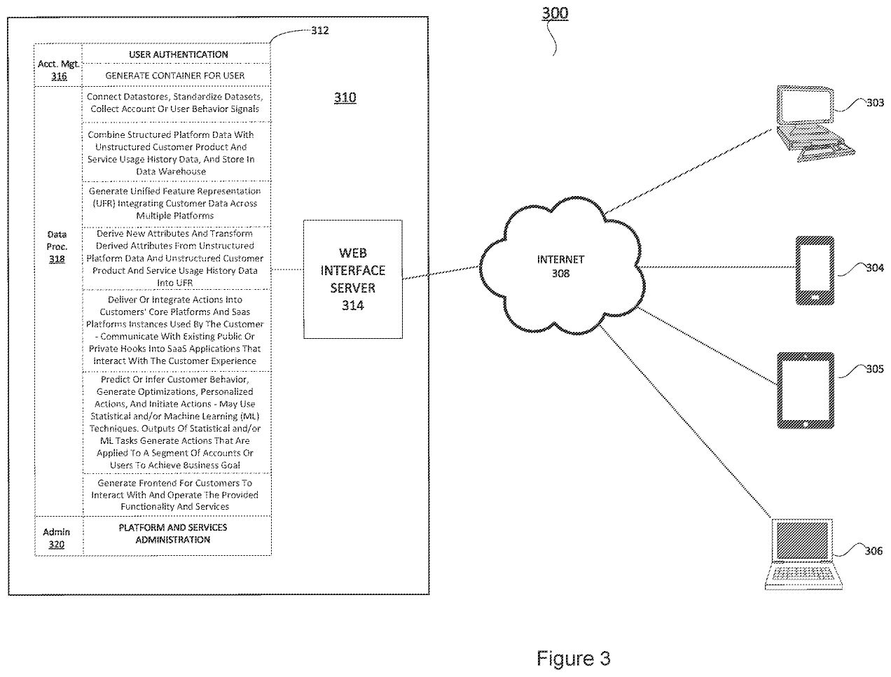

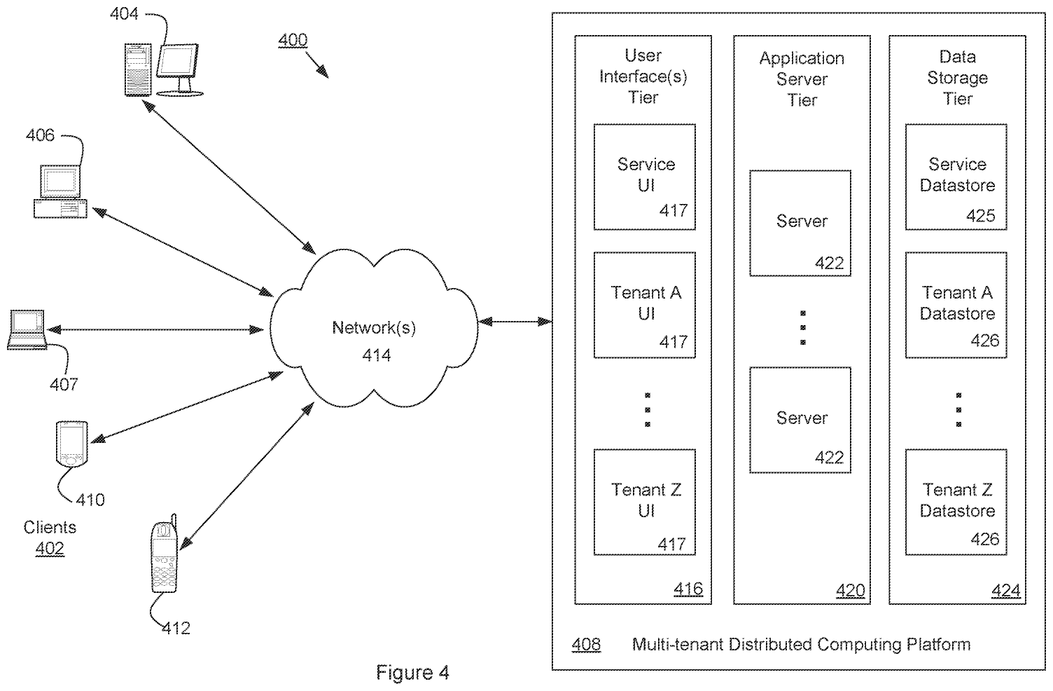

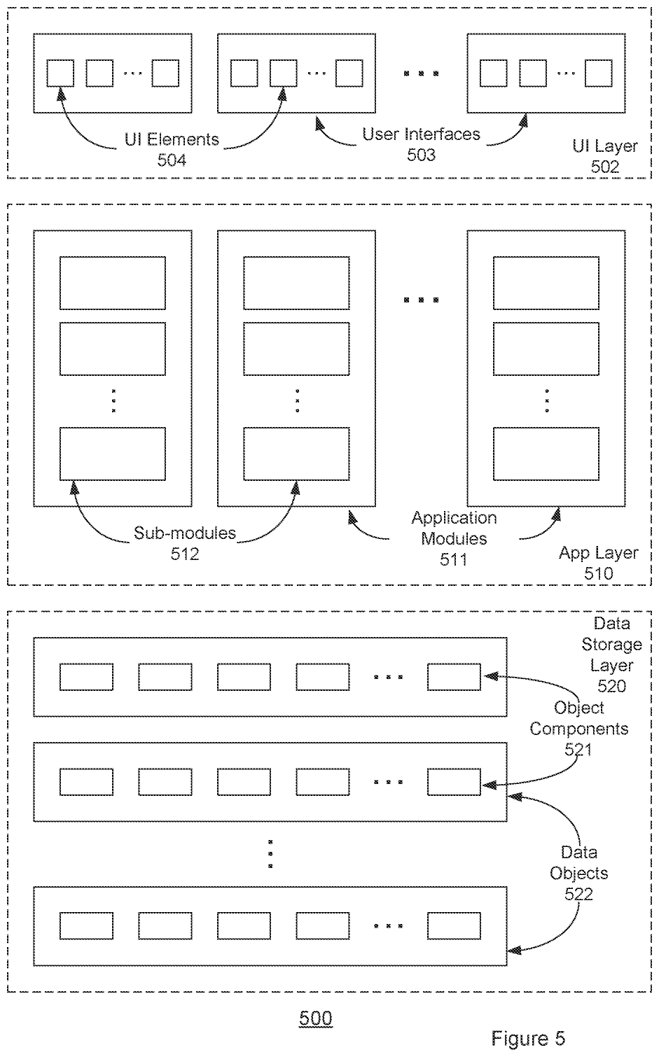

In some embodiments, the functionality and services provided by the system and methods described herein may be made available to multiple users by accessing a presence and set of functions or capabilities maintained by a server or service platform. Such a server or service platform may be termed a form of Software-as-a-Service (SaaS). FIG. 3 is a diagram illustrating a SaaS system in which an embodiment of the disclosure may be implemented. FIG. 4 is a diagram illustrating elements or components of an example operating environment in which an embodiment of the disclosure may be implemented. FIG. 5 is a diagram illustrating additional details of the elements or components of the multi-tenant distributed computing service platform of FIG. 4, in which an embodiment of the disclosure may be implemented.

In some embodiments, the system or service(s) described herein may be implemented as micro-services, processes, workflows, or functions performed in response to a user request. The micro-services, processes, workflows, or functions may be performed by a server, data processing element, platform, or system. In some embodiments, the services may be provided by a service platform located “in the cloud”. In such embodiments, the platform is accessible through APIs and SDKs. The described services may be provided as micro-services within the platform for each of multiple users or companies. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 3-5 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide the services disclosed and/or described herein.

Although in some embodiments, a platform or system of the type illustrated in FIGS. 3-5 may be operated by a 3^{rd} party provider to provide a specific set of business-related applications, in other embodiments, the platform may be operated by a provider and a different business may provide the applications or services for users through the platform. For example, some of the functions and services described with reference to FIGS. 3-5 may be provided by a 3^{rd} party, with the provider of the platform maintaining a presence on the platform for each customer company or business of the 3^{rd} party.

FIG. 3 is a diagram illustrating a system 300 in which an embodiment of the disclosure may be implemented or through which an embodiment of the services disclosed and/or described herein may be accessed. In accordance with the advantages of an application service provider (ASP) hosted business service system (such as a multi-tenant data processing platform), users of the services disclosed and/or described herein may comprise individuals, businesses, or organizations, as examples.

An entity or authorized individual may access the provided services using a suitable client. Entities or individuals interface with the service platform across the Internet 308 or another suitable communications network or combination of networks. Examples of suitable client devices include desktop computers 303, smartphones 304, tablet computers 305, or laptop computers 306.

System 310, which may be hosted by a third party, may include a set of services 312 and a web interface server 314, coupled as shown in FIG. 3. It is to be appreciated that either or both services 312 and the web interface server 314 may be implemented on one or more different hardware systems and components, even though represented as singular units in FIG. 3. Services 312 may include one or more functions or operations for improving the post-sale customer satisfaction with software applications and services, as disclosed and/or described herein.

In some embodiments, the set of services or applications available to an entity or authorized individual may include one or more that perform the functions and methods disclosed and/or described herein with reference to the Figures. As examples, in some embodiments, the set of applications, functions, operations or services made available through the platform or system 310 may include:
account management services 316, such as
   a process or service to authenticate an entity or individual wishing to access the services/applications available through the platform (such as credentials or proof of purchase, or verification that the entity/individual has been authorized to use the services);
   a process or service to generate a container or instantiation of the services, methodology, applications, functions, and operations disclosed and/or described, where the instantiation may be customized for a particular entity; and
   other forms of account management services;
a set 318 of data processing services, applications, and functionality, such as a process or service to perform one or more of:
   Connect Datastores, Standardize Datasets, Collect Account or User Behavior Signals;
   Combine Structured Platform Data with Unstructured Customer Product and Service Usage History Data, and Store in Data Warehouse;
   Generate a Unified Feature Representation (UFR) Integrating Customer Data Across Multiple Platforms;
   Derive New Attributes and Transform Derived Attributes from Unstructured Platform Data and Unstructured Customer Product and Service Usage History Data into the UFR;
   Deliver or Integrate Actions into Customers' Core Platforms and SaaS Platforms Instances Used by the Customer—Communicate with Existing Public or Private Hooks into SaaS Applications that Interact with the Customer/User Experience;
   Predict or Infer Customer Behavior, Generate Optimizations, Personalized Actions, And Initiate Actions—May Use Statistical and/or Machine Learning (ML) Techniques to Perform Tasks Related to Generating Inferences, Predictions, or Recommendations. Outputs of Statistical and/or ML Tasks Generate Actions That Are Applied to a Segment of Accounts or Users to Achieve a Desired Business Goal;
   Generate Frontend for Customers to Interact with and Operate the Provided Functionality and Services—Support Ability to Orchestrate Actions, Gather Insights and Actions Taken on Predictions, and Add/Remove Data Stores and Manage Platform Integrations;
administrative services 320, such as
   a process or services to enable the provider of the data processing services and/or the platform to administer and configure the processes and services provided to customers, accounts, or users.

The platform or system shown in FIG. 3 may be hosted on a distributed computing system made up of at least one, but typically multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, web server, etc. A web server is a most often a combination of hardware and the software that helps deliver content, commonly by hosting a website, to client web browsers that access the web server via the Internet.

FIG. 4 is a diagram illustrating elements or components of an example operating environment 400 in which an embodiment of the disclosure may be implemented. As shown, a variety of clients 402 incorporating and/or incorporated into a variety of computing devices may communicate with a multi-tenant service platform 408 through one or more networks 414. For example, a client may incorporate and/or be incorporated into a client application (e.g., software) implemented at least in part by one or more of the computing devices.

Examples of suitable computing devices include personal computers, server computers 404, desktop computers 406, laptop computers 407, notebook computers, tablet computers or personal digital assistants (PDAs) 410, smart phones 412, cell phones, and consumer electronic devices incorporating one or more computing device components, such as one or more electronic processors, microprocessors, central processing units (CPU), or controllers. Examples of suitable networks 414 include networks utilizing wired and/or wireless communication technologies and networks operating in accordance with any suitable networking and/or communication protocol (e.g., the Internet).

The distributed computing service/platform (which may also be referred to as a multi-tenant data processing platform) 408 may include multiple processing tiers, including a user interface tier 416, an application server tier 420, and a data storage tier 424. The user interface tier 416 may maintain multiple user interfaces 417, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, causing the execution of specific data processing operations, etc. Each application server or processing tier 422 shown in the figure may be implemented with a set of computers and/or components including computer servers and processors, and may perform various functions, methods, processes, or operations as determined by the execution of a software application or set of instructions. The data storage tier 424 may include one or more data stores, which may include a Service Data store 425 and one or more Tenant Data stores 426. Data stores may be implemented with any suitable data storage technology, including structured query language (SQL) based relational database management systems (RDBMS).

Service Platform 408 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 422 that are part of the platform's Application Server Tier 420. As noted with regards to FIG. 3, the platform system shown in FIG. 4 may be hosted on a distributed computing system made up of at least one, but typically multiple, “servers.”

As mentioned, rather than build and maintain such a platform or system themselves, a business may utilize systems provided by a third party. A third party may implement a business system/platform as described above in the context of a multi-tenant platform, where individual instantiations of a business' data processing workflow (such as the data processing and machine learning or other modeling services described herein) are provided to users, with each company/business representing a tenant of the platform. One advantage to such multi-tenant platforms is the ability for each tenant to customize their instantiation of the data processing workflow to that tenant's specific business needs or operational methods. Each tenant may be a business or entity that uses the multi-tenant platform to provide business services and functionality to multiple end-users.

FIG. 5 is a diagram illustrating additional details of the elements or components of the multi-tenant distributed computing service platform of FIG. 4, in which an embodiment of the disclosure may be implemented. The software architecture shown in FIG. 5 represents an example of an architecture which may be used to implement an embodiment of the disclosure. In general, an embodiment may be implemented using a set of software instructions that are designed to be executed by a suitably programmed processing element (such as a CPU, microprocessor, processor, controller, computing device, etc.). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 5 is a diagram illustrating additional details of the elements or components 500 of a multi-tenant distributed computing service platform, in which an embodiment of the disclosure may be implemented. The example architecture includes a user interface layer or tier 502 having one or more user interfaces 503. Examples of such user interfaces include graphical user interfaces and application programming interfaces (APIs). Each user interface may include one or more interface elements 504. For example, users may interact with interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 510 may include one or more application modules 511, each having one or more sub-modules 512. Each application module 511 or sub-module 512 may correspond to a function, method, process, or operation that is implemented by the module or sub-module (e.g., a function or process related to providing business related data processing and services to a user of the platform). Such function, method, process, or operation may include those used to implement one or more aspects of the disclosed and/or described system and methods, such as for one or more of the processes, services, or functions described with reference to the Figures:
Connect Datastores, Standardize Datasets, Collect Account or User Behavior Signals;
Combine Structured Platform Data with Unstructured Customer Product and Service Usage History Data, and Store in Data Warehouse;
Generate Unified Feature Representation (UFR) Integrating Customer Data Across Multiple Platforms;
Derive New Attributes and Transform Derived Attributes from Unstructured Platform Data and Unstructured Customer Product and Service Usage History Data into the UFR;
Deliver or Integrate Actions into Customers' Core Platforms and Saas Platforms Instances Used by The Customer—Communicate with Existing Public or Private Hooks into SaaS Applications That Interact with the Customer Experience;
Predict or Infer Customer Behavior, Generate Optimizations, Personalized Actions, And Initiate Actions—May Use Statistical and/or Machine Learning (ML) Techniques to Perform Tasks Related to Generating Inferences, Predictions, Or Recommendations. Outputs of Statistical and/or ML Tasks Generate Actions That Are Applied to a Segment of Accounts or Users to Achieve a Desired Business Goal;
Generate Frontend for Customers to Interact with and Operate the Provided Functionality and Services—Support Ability to Orchestrate Actions, Gather Insights and Actions Taken on Predictions, and Add/Remove Data Stores and Manage Platform Integrations.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 422 of FIG. 4) may include each application module. Alternatively, different application servers may include different sets of application modules. Such sets may be disjoint or overlapping.

The data storage layer 520 may include one or more data objects 522 each having one or more data object components 521, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 3-5 are not intended to be limiting examples. Further environments in which an embodiment of the invention may be implemented in whole or in part include devices (including mobile devices), software applications, systems, apparatuses, networks, SaaS platforms, laaS (infrastructure-as-a-service) platforms, or other configurable components that may be used by multiple users for data entry, data processing, application execution, or data review.

This disclosure includes the following clauses and embodiments:
1. A method, comprising:
accessing data from one or more datastores of a customer, wherein the customer is an entity providing a product or service to one or more accounts, with each account associated with one or more users of the product or service;
for each account, obtaining data representing usage of the product or service by the account or by the one or more users of the product or service;
generating a Unified Feature Representation (UFR) for the accessed data of the customer and the obtained data representing usage of the product or service by the account or by the one or more users of the product or service;
identifying a business goal of the customer;
for the identified business goal of the customer, predicting or inferring one or more of account or user behavior that is expected to assist in achieving the business goal of the customer;
generating a proposed set of actions for an account or user to take to assist in achieving the business goal of the customer;
presenting the proposed set of actions to the customer; and
providing one or more displays or user interface elements to enable the customer to interact with and manage the proposed set of actions.
2. A system, comprising:
at least one electronic processor;
an electronic non-transitory data storage element including a set of computer-executable instructions that, when executed by the electronic processor, cause the system to:
   access data from one or more datastores of a customer, wherein the customer is an entity providing a product or service to one or more accounts, with each account associated with one or more users of the product or service;
   for each account, obtain data representing usage of the product or service by the account or by the one or more users of the product or service;
   generate a Unified Feature Representation (UFR) for the accessed data of the customer and the obtained data representing usage of the product or service by the account or by the one or more users of the product or service;
   identify a business goal of the customer;
   for the identified business goal of the customer, predict or infer one or more of account or user behavior that is expected to assist in achieving the business goal of the customer;
   generate a proposed set of actions for an account or user to take to assist in achieving the business goal of the customer;
   present the proposed set of actions to the customer; and
   provide one or more displays or user interface elements to enable the customer to interact with and manage the proposed set of actions.
3. One or more non-transitory computer-readable media comprising a set of computer-executable instructions that when executed by one or more programmed electronic processors, cause the processors to:
access data from one or more datastores of a customer, wherein the customer is an entity providing a product or service to one or more accounts, with each account associated with one or more users of the product or service;
for each account, obtain data representing usage of the product or service by the account or by the one or more users of the product or service;
generate a Unified Feature Representation (UFR) for the accessed data of the customer and the obtained data representing usage of the product or service by the account or by the one or more users of the product or service;
identify a business goal of the customer;
for the identified business goal of the customer, predict or infer one or more of account or user behavior that is expected to assist in achieving the business goal of the customer;
generate a proposed set of actions for an account or user to take to assist in achieving the business goal of the customer;
present the proposed set of actions to the customer; and
provide one or more displays or user interface elements to enable the customer to interact with and manage the proposed set of actions.
4. A method, comprising:
accessing software application data generated by a user's interactions with a software application, wherein the software application is provided by an entity;
accessing signals generated by a user when the user interacts with the software application;
operating a first trained model to predict data generated by the user's interactions with the software application based on the accessed software application data and generated signals;
identifying a business goal of the entity;
determining a relationship between the identified business goal of the entity and the software application data generated by the user's interactions with the software application;
determining one or more user generated signals or user interactions with the software application expected to assist in achieving the business goal of the entity;
operating a second trained model to generate one or more recommended actions to present to the entity to cause the user to generate the one or more signals or perform the user interactions to assist in achieving the business goal;
delivering the one or more recommended actions to the entity; and
generating a set of user interface displays and tools enable the entity to interact with and operate the functionality of one or more of the preceding steps.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Machine learning (ML) is being used more and more to enable the analysis of data and assist in making decisions in multiple industries. To benefit from using machine learning, a machine learning algorithm is applied to a set of training data and labels to generate a “model” which represents what the application of the algorithm has “learned” from the training data. Each element (or instances or example, in the form of one or more parameters, variables, characteristics or “features”) of the set of training data is associated with a label or annotation that defines how the element should be classified by the trained model. A machine learning model in the form of a neural network is a set of layers of connected neurons that operate to make a decision (such as a classification) regarding a sample of input data. When trained (i.e., the weights connecting neurons have converged and become stable or within an acceptable amount of variation), the model will operate on a new element of input data to generate the correct label or classification as an output.

In some embodiments, certain of the methods, models or functions disclosed and/or described herein may be embodied in the form of a trained neural network, where the network is implemented by the execution of a set of computer-executable instructions or representation of a data structure. The instructions may be stored in (or on) a non-transitory computer-readable medium and executed by a programmed processor or processing element. The set of instructions may be conveyed to a user through a transfer of instructions or an application that executes a set of instructions (such as over a network, e.g., the Internet). The set of instructions or an application may be utilized by an end-user through access to a SaaS platform ora service provided through such a platform.

A trained neural network, trained machine learning model, or any other form of decision or classification process may be used to implement one or more of the methods, functions, processes, or operations described herein. Note that a neural network or deep learning model may be characterized in the form of a data structure in which are stored data representing a set of layers containing nodes, and connections between nodes in different layers are created (or formed) that operate on an input to provide a decision or value as an output.

In general terms, a neural network may be viewed as a system of interconnected artificial “neurons” (nodes) that exchange messages between each other. The connections have numeric weights that are “tuned” during a training process, so that a properly trained network will respond correctly when presented with an image or pattern to recognize (for example). In this characterization, the network consists of multiple layers of feature-detecting “neurons”; each layer has neurons that respond to different combinations of inputs from the previous layers. Training of a network is performed using a “labeled” dataset of inputs in a wide assortment of representative input patterns that are associated with their intended output response. Training uses general-purpose methods to iteratively determine the weights for intermediate and final feature neurons. In terms of a computational model, each neuron calculates the dot product of inputs and weights, adds the bias, and applies a non-linear trigger or activation function (for example, using a sigmoid response function).

Any of the software components, processes or functions described in this application may be implemented as software code to be executed by a processor using any suitable computer language such as Python, Java, JavaScript, C, C++, or Perl using procedural, functional, object-oriented, or other techniques. The software code may be stored as a series of instructions, or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, may be implemented by computer-executable program instructions. Note that in some embodiments, one or more of the blocks, or stages or steps may not necessarily need to be performed in the order presented or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that may direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein may be performed in any suitable order unless otherwise indicated herein or clearly contradicted by context. The use of any examples, or exemplary language (e.g., “such as”) provided herein, is intended merely to better illuminate embodiments of the disclosure, and do not pose a limitation to the scope of the disclosure unless otherwise claimed. No language in the specification should be construed as indicating any non-claimed element as essential to each embodiment.

As used herein (i.e., the claims, figures, and specification), the term “or” is used inclusively to refer to items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this disclosure. Accordingly, the disclosure is not limited to the embodiments described herein or depicted in the drawings, and various embodiments and modifications may be made without departing from the scope of the claims below.

What is claimed is:

1. A method, comprising:
accessing data from one or more datastores of a customer, wherein the customer is an entity providing a product or service to one or more accounts, with each account associated with one or more users of the product or service;
for each account, obtaining data representing usage of the product or service by the account or by the one or more users of the product or service;
generating a Unified Feature Representation (UFR) for the accessed data of the customer and the obtained data representing usage of the product or service by the account or by the one or more users of the product or service;
identifying a business goal of the customer;
for the identified business goal of the customer, predicting or inferring one or more of account or user behavior that is expected to assist in achieving the business goal of the customer;
generating a proposed set of actions for an account or user to take to assist in achieving the business goal of the customer;
presenting the proposed set of actions to the customer; and
providing one or more displays or user interface elements to enable the customer to interact with and manage the proposed set of actions.

2. The method of claim 1, wherein the one or more datastores include customer relationship management (CRM) data, the CRM data including a list of accounts to which the customer provides the product or service.

3. The method of claim 1, wherein the data representing usage of the product or service by the account or a user or users of the product or service associated with the account further comprises one or more of keystrokes, entered data, entered alphanumeric strings, signals generated by a software application, an instruction or command executed by a software application or service, an event generated in response to a signal, or a user input.

4. The method of claim 1, wherein generating the Unified Feature Representation (UFR) for the accessed data of the customer and the obtained data representing usage of the product or service by the account or by the one or more users of the product or service further comprises:
determining one or more features of the accessed or obtained data; and
representing the Unified Feature Representation as a feature vector in a multi-dimensional vector space corresponding to the one or more features.

5. The method of claim 4, wherein determining one or more features of the accessed or obtained data further comprises evaluating each feature of the feature vector for its predictive importance or deriving a new attribute from the one or more features and representing the new attribute in a format corresponding to the UFR.

6. The method of claim 5, wherein evaluating each feature of the feature vector for its predictive importance further comprises using one or more of a trained machine learning model, regression, classification, or correlation analysis.

7. The method of claim 1, wherein the business goal of the customer is one or more of reducing churn, increasing productivity of uses of the product or service provided by the customer, increased revenue, increased profit, increased deal flow, improved employee retention, or decreased requests for support assistance for the product or service.

8. The method of claim 1, wherein predicting or inferring one or more of account or user behavior that is expected to assist in achieving the business goal of the customer further comprises using one or more of a trained machine learning model to generate an expected result of a specific account or user action or behavior, A/B testing, constructing a simulation, or applying a causal inference technique to actions previously applied to an account or user.

9. The method of claim 1, wherein generating a proposed set of actions for an account or user to take to assist in achieving the business goal of the customer further comprises using a trained machine learning model to generate one or more actions to propose to an account or user, wherein the one or more actions are expected to assist in achieving the business goal based on the expected result of the account or user action or behavior.

10. A system, comprising:
at least one electronic processor;
an electronic non-transitory data storage element including a set of computer-executable instructions that, when executed by the electronic processor, cause the system to:
access data from one or more datastores of a customer, wherein the customer is an entity providing a product or service to one or more accounts, with each account associated with one or more users of the product or service;
for each account, obtain data representing usage of the product or service by the account or by the one or more users of the product or service;
generate a Unified Feature Representation (UFR) for the accessed data of the customer and the obtained data representing usage of the product or service by the account or by the one or more users of the product or service;
identify a business goal of the customer;
for the identified business goal of the customer, predict or infer one or more of account or user behavior that is expected to assist in achieving the business goal of the customer;
generate a proposed set of actions for an account or user to take to assist in achieving the business goal of the customer;
present the proposed set of actions to the customer; and
provide one or more displays or user interface elements to enable the customer to interact with and manage the proposed set of actions.

11. The system of claim 10, wherein the one or more datastores include customer relationship management (CRM) data, the CRM data including a list of accounts to which the customer provides the product or service.

12. The system of claim 10, wherein the data representing usage of the product or service by the account or a user or users of the product or service associated with the account further comprises one or more of keystrokes, entered data, entered alphanumeric strings, signals generated by a software application, an instruction or command executed by a software application or service, an event generated in response to a signal, or a user input.

13. The system of claim 10, wherein generating the Unified Feature Representation (UFR) for the accessed data of the customer and the obtained data representing usage of the product or service by the account or by the one or more users of the product or service further comprises:
determining one or more features of the accessed or obtained data; and
representing the Unified Feature Representation as a feature vector in a multi-dimensional vector space corresponding to the one or more features.

14. The system of claim 13, wherein determining one or more features of the accessed or obtained data further comprises evaluating each feature of the feature vector for its predictive importance or deriving a new attribute from the one or more features and representing the new attribute in a format corresponding to the UFR.

15. The system of claim 10, wherein the business goal of the customer is one or more of reducing churn, increasing productivity of uses of the product or service provided by the customer, increased revenue, increased profit, increased deal flow, improved employee retention, or decreased requests for support assistance for the product or service.

16. The system of claim 10, wherein predicting or inferring one or more of account or user behavior that is expected to assist in achieving the business goal of the customer further comprises using one or more of a trained machine learning model to generate an expected result of a specific account or user action or behavior, A/B testing, constructing a simulation, or applying a causal inference technique to actions previously applied to an account or user.

17. The system of claim 10, wherein generating a proposed set of actions for an account or user to take to assist in achieving the business goal of the customer further comprises using a trained machine learning model to generate one or more actions to propose to an account or user, wherein the one or more actions are expected to assist in achieving the business goal based on the expected result of the account or user action or behavior.

18. One or more non-transitory computer-readable media comprising a set of computer-executable instructions that when executed by one or more programmed electronic processors, cause the processors to:
access data from one or more datastores of a customer, wherein the customer is an entity providing a product or service to one or more accounts, with each account associated with one or more users of the product or service;
for each account, obtain data representing usage of the product or service by the account or by the one or more users of the product or service;
generate a Unified Feature Representation (UFR) for the accessed data of the customer and the obtained data representing usage of the product or service by the account or by the one or more users of the product or service;
identify a business goal of the customer;
for the identified business goal of the customer, predict or infer one or more of account or user behavior that is expected to assist in achieving the business goal of the customer;
generate a proposed set of actions for an account or user to take to assist in achieving the business goal of the customer;
present the proposed set of actions to the customer; and
provide one or more displays or user interface elements to enable the customer to interact with and manage the proposed set of actions.

19. The one or more non-transitory computer-readable media of claim 18, wherein the one or more datastores include customer relationship management (CRM) data, the CRM data including a list of accounts to which the customer provides the product or service.

20. The one or more non-transitory computer-readable media of claim 18, wherein the business goal of the customer is one or more of reducing churn, increasing productivity of uses of the product or service provided by the customer, increased revenue, increased profit, increased deal flow, improved employee retention, or decreased requests for support assistance for the product or service.
